(19) United States
(12) Patent Application Publication
(10) Pub. No.: US 2025/0037236 A1
(43) Pub. Date: Jan. 30, 2025

(54) IMAGE PROCESSING APPARATUS, IMAGE PROCESSING METHOD, AND IMAGE CAPTURE APPARATUS

(71) Applicant: CANON KABUSHIKI KAISHA, Tokyo (JP)

(72) Inventors: TAKAO SASAKI, Kanagawa (JP); YOSHITAKA SASAKI, Kanagawa (JP)

(21) Appl. No.: 18/764,750

(22) Filed: Jul. 5, 2024

(30) Foreign Application Priority Data
Jul. 28, 2023 (JP) 2023-123765
Feb. 21, 2024 (JP) 2024-024825

(51) Int. Cl. G06T 3/4046; G06T 3/4038; H04N 23/69

(52) U.S. Cl. CPC G06T 3/4046; G06T 3/4038; H04N 23/69

(57) ABSTRACT

An image processing apparatus that upscales a partial region of an image using an upscaling method in which upscaling is performed in a block unit is disclosed. The apparatus divides an image into blocks, performs upscaling processing on each block, and then combines upscaled images of the blocks into one upscaled image. In a case where an upscaled image of a partial region of an original image is to be generated, the apparatus divides the partial region into a plurality of blocks at predetermined positions regardless of a position of the partial region in the original image.

### BACKGROUND OF THE INVENTION

### Field of the Invention

The present invention relates to an image processing apparatus, an image processing method, and an image capture apparatus, and particularly relates to a technique for enlarging an image.

### Description of the Related Art

A technique for enlarging an image (increasing the number of pixels), also called “upscaling”, is widely used. Upscaling using a trained machine learning model (also called “machine learning (ML)-based upscaling” hereinafter) is attracting attention in recent years (Japanese Patent Laid-Open No. 2022-505275).

As the size of the image to be upscaled (the number of pixels) increases, a greater amount of memory and computation is required for the upscaling. In ML-based upscaling in particular, the amount of memory and computation required increases exponentially with the image size. In response to this, upscaling images in smaller units of a specific size, i.e., blocks, makes it possible to upscale images of various sizes using only the amount of memory required for upscaling a single block.

However, differences in the processing accuracy, processing time, and the like of the upscaling processing arise depending on the method for setting the blocks.

These issues are not limited to ML-based upscaling, and also arise in upscaling based on the interpolation of pixel values such as bicubic interpolation.

### SUMMARY OF THE INVENTION

The present invention provides, in one aspect, an image processing apparatus capable of at least suppressing the issue described in the related art which arises when generating an image in which a partial region of an original image is upscaled using a method of upscaling an image in units of blocks.

According to an aspect of the present invention, there is provided an image processing apparatus comprising: one or more processors that execute a program stored in a memory and thereby function as: a dividing unit configured to divide an image into a plurality of blocks; a processing unit configured to perform upscaling processing on each of the plurality of blocks; and a combining unit configured to combine upscaled images of the plurality of blocks into one upscaled image, wherein, in a case where an upscaled image of a partial region of an original image is to be generated, the dividing unit divides the partial region into a plurality of blocks at predetermined positions regardless of a position of the partial region in the original image.

According to another aspect of the present invention, there is provided an image processing apparatus comprising: one or more processors that execute a program stored in a memory and thereby function as: a dividing unit configured to divide an image into a plurality of blocks; a processing unit configured to perform upscaling processing on each of the plurality of blocks; and a combining unit configured to combine upscaled images of the plurality of blocks into one upscaled image, wherein in a case where an upscaled image of a partial region of an original image is to be generated, the processing unit sets a processing region that contains the partial region and that is smaller than the original image and larger than the partial region, and performs the upscaling processing for each of a plurality of blocks obtained by dividing the processing region in accordance with a position of the partial region, and the partial region of the one upscaled image obtained by the combining unit is cropped.

According to a further aspect of the present invention, there is provided an image capture apparatus comprising: an image sensor; and an image processing apparatus that takes an image captured using the image sensor as an original image, wherein the image processing apparatus comprising: one or more processors that execute a program stored in a memory and thereby function as: a dividing unit configured to divide an image into a plurality of blocks; a processing unit configured to perform upscaling processing on each of the plurality of blocks; and a combining unit configured to combine upscaled images of the plurality of blocks into one upscaled image, wherein, in a case where an upscaled image of a partial region of an original image is to be generated, the dividing unit divides the partial region into a plurality of blocks at predetermined positions regardless of a position of the partial region in the original image.

According to another aspect of the present invention, there is provided an image processing method performed by an image processing apparatus, the image processing method comprising: dividing an image into a plurality of blocks; performing upscaling processing on each of the plurality of blocks; and combining upscaled images of the plurality of blocks into one upscaled image, wherein in a case where an upscaled image of a partial region of an original image is to be generated, the dividing divides the partial region into a plurality of blocks at predetermined positions regardless of a position of the partial region in the original image.

According to a further aspect of the present invention, there is provided an image processing method performed by an image processing apparatus, the image processing method comprising: dividing an image into a plurality of blocks; performing upscaling processing on each of the plurality of blocks; and combining upscaled images of the plurality of blocks into one upscaled image, wherein in a case where an upscaled image of a partial region of an original image is to be generated, the performing of the upscaling processing sets a processing region that contains the partial region and that is smaller than the original image and larger than the partial region, and performs the upscaling processing for each of the plurality of blocks obtained by dividing the processing region in accordance with a position of the partial region, and the partial region of the one upscaled image obtained from the combining is cropped.

Further features of the present invention will become apparent from the following description of exemplary embodiments (with reference to the attached drawings).

### BRIEF DESCRIPTION OF THE DRAWINGS

FIG. 1 is a block diagram illustrating an example of the functional configuration of an image capture apparatus serving as an example of an image processing apparatus according to embodiments.

FIG. 2 is a flowchart illustrating upscaling processing according to a first embodiment.

FIG. 3 is a flowchart illustrating upscaling processing according to a second embodiment.

FIGS. 4A to 4C are diagrams illustrating block division positions in upscaling processing.

FIGS. 5A and 5B are diagrams illustrating upscaling processing according to the second embodiment.

FIG. 6 is a flowchart illustrating upscaling processing according to a third embodiment.

FIG. 7 is a diagram illustrating block division in the third embodiment.

FIG. 8 is a flowchart illustrating block size determination processing according to a fourth embodiment.

FIG. 9 is a diagram illustrating processing for calculating a number of excessive pixels according to the fourth embodiment.

### DESCRIPTION OF THE EMBODIMENTS

Hereinafter, embodiments will be described in detail with reference to the attached drawings. Note, the following embodiments are not intended to limit the scope of the claimed invention. Multiple features are described in the embodiments, but limitation is not made to an invention that requires all such features, and multiple such features may be combined as appropriate. Furthermore, in the attached drawings, the same reference numerals are given to the same or similar configurations, and redundant description thereof is omitted.

The following embodiments will describe a case where the present invention is applied in an image capture apparatus (a digital camera). However, the present invention does not require an image capture function. The present invention can be carried out in any electronic device capable of handling image data. Examples of such an electronic device include computer devices (personal computers, tablet computers, media players, PDAs, and the like), smartphones, game consoles, robots, drones, and dashboard cameras, in addition to image capture apparatuses. These are merely examples, however, and the present invention can be applied in other electronic devices as well.

### First Embodiment

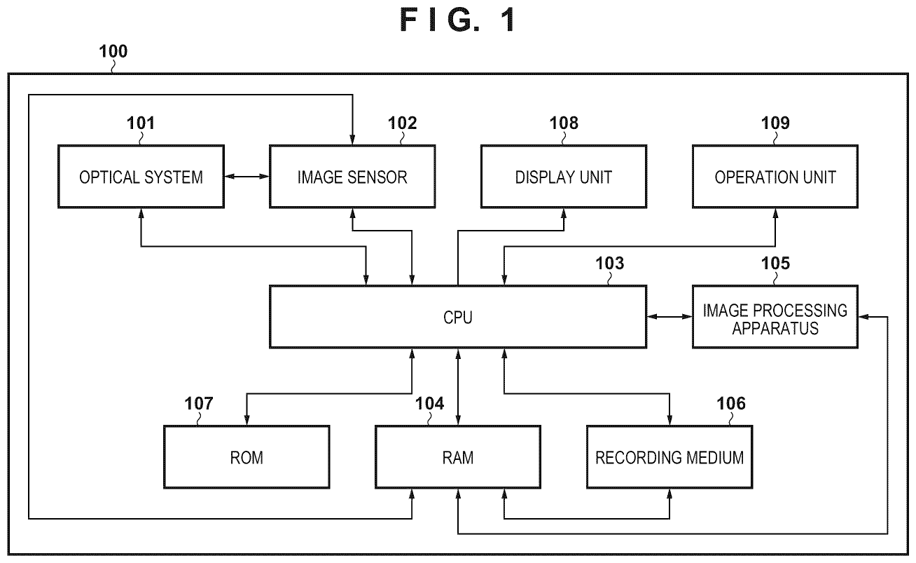

FIG. 1 is a block diagram illustrating an example of the basic functional configuration of an image capture apparatus 100 serving as an example of an image processing apparatus according to a first embodiment of the present invention. Aside from parts that can clearly only be implemented by hardware (e.g., lenses provided in an optical system 101, pixels in an image sensor 102, and the like), the function blocks in the image capture apparatus 100 can be implemented by software, or by a combination of software and hardware. For example, the function blocks may be implemented by dedicated hardware such as ASICs. Alternatively, the function blocks may be implemented by a processor such as a CPU executing programs stored in the memory. Note also that multiple function blocks may be implemented by a shared configuration (e.g., a single ASIC). Furthermore, hardware implementing some functions of a given function block may be included in hardware implementing another function block.

The optical system 101 includes a plurality of lenses including a movable lens, a shutter, an aperture stop, a motor that drives movable members, an actuator, and the like. The movable lens includes a focus lens for adjusting the focal distance of the optical system, a zoom lens for adjusting the focal length (angle of view) of the optical system 101, and the like. The operations of the optical system 101 are controlled by a CPU 103 serving as a control circuit or a controller of the image capture apparatus 100.

The optical system 101 forms an optical image of a subject on an image capturing surface of the image sensor 102. The image sensor 102 may be a publicly-known CCD or CMOS color image sensor having, for example, a primary color Bayer array color filter. The image sensor 102 includes a pixel array, in which a plurality of pixels are arranged two-dimensionally, and peripheral circuitry for reading out signals from the pixels. Each pixel accumulates a charge corresponding to an amount of incident light through photoelectric conversion. By reading out, from each pixel, a signal having a voltage corresponding to the charge amount accumulated during an exposure period, a group of pixel signals (analog image signals) representing a subject image formed on the image capturing surface is obtained. The analog image signal is A/D converted by the CPU 103 and is stored in a RAM 104. The image sensor 102 may have an A/D conversion function.

The CPU 103 controls the operations of each function block of the image capture apparatus 100 by, for example, loading a program stored in a ROM 107 into the RAM 104 and executing the program to implement the functions of the image capture apparatus 100. Additionally, the CPU 103 performs automatic focus detection (AF), automatic exposure control (AE), and control of the operations of the optical system 101 and the image sensor 102 in accordance with AF and AE results.

The ROM 107 is a rewritable non-volatile memory, and stores programs executed by the CPU 103, various types of setting values of the image capture apparatus 100, image data (GUI data) for a menu screen and an on-screen display (OSD), and the like.

The RAM 104 is used as a main memory for the CPU 103, a buffer for temporarily storing captured image data, a work memory for an image processing apparatus 105, and the like. Part of the RAM 104 may also be used as video memory for storing display image data.

The image processing apparatus 105 generates signals and image data for different purposes, obtains and/or generates various types of information, and so on by applying predetermined image processing to the image data stored in the RAM 104. The image processing apparatus 105 may be a dedicated hardware circuit, such as an application specific integrated circuit (ASIC) designed to implement a specific function, for example. Alternatively, the image processing apparatus 105 may be constituted by a processor such as a digital signal processor (DSP) or a graphics processing unit (GPU) executing software to implement a specific function. The image processing apparatus 105 outputs the obtained or generated information, data, and the like to the CPU 103, the RAM 104, or the like, according to the purpose of use.

The image processing applied by the image processing apparatus 105 can include pre-processing, color interpolation processing, correction processing, detection processing, data processing, evaluation value calculation processing, special effect processing, and so on, for example.

The pre-processing includes signal amplification, reference level adjustment, defective pixel correction, and the like.

The color interpolation processing is performed when the image sensor is provided with a color filter, and interpolates the values of color components that are not included in the individual pixel data constituting the image data. Color interpolation processing is also called “demosaicing”.

The correction processing can include white balance adjustment, tone adjustment, correction of image degradation caused by optical aberrations of the optical system 101 (image restoration), correction of the effects of vignetting in the optical system 101, color correction, and the like.

The detection processing includes detecting a feature region (e.g., a face region or a human body region) or motion in such an area, processing for recognizing a person, or the like.

The data processing can include cropping a region (trimming), combining, scaling, encoding and decoding, and header information generation (data file generation). The generation of display image data and recording image data is also included in the data processing.

The evaluation value calculation processing can include processing such as generating signals, evaluation values, and the like used in automatic focus detection (AF), generating evaluation values used in automatic exposure control (AE), and the like.

The special effect processing includes adding bokeh effects, changing color tones, relighting processing, and the like.

Note that these are merely examples of processing that can be applied by the image processing apparatus 105, and are not intended to limit the processing applied by the image processing apparatus 105. Some of the processing described herein may be implemented by the CPU 103 executing programs.

In the present embodiment, the image processing apparatus 105 performs upscaling. The upscaling can be performed using any publicly-known method. When performing ML-based upscaling, the image processing apparatus 105 is provided with a trained machine learning model configured to upscale an input image of a specific size at a predetermined magnification and output the upscaled image. The machine learning model can be implemented, for example, using a two-dimensional convolutional neural network (CNN). Note that machine learning models that perform ML-based upscaling are publicly-known, such as that described in Japanese Patent Laid-Open No. 2022-505275, for example, and will therefore not be described in detail here. When performing non-ML-based upscaling, the image processing apparatus 105 performs upscaling using a publicly-known method that does not use a machine learning model, such as bicubic interpolation, for example.

Regardless of the method used for the upscaling, the present embodiment assumes that the upscaling is performed in units of blocks of a predetermined size. A “block” is a rectangular image region, and has a size that is sufficiently small relative to the size of the image being handled by the image capture apparatus 100 (e.g., a captured image). Here, as an example, the block is assumed to be a square region having 64 pixels or 128 pixels to a side. This is sufficiently small for the resolution of images that are typically used (millions of pixels or more).

A recording medium 106 is, for example, a semiconductor memory card that can be attached to and detached from the image capture apparatus 100. The CPU 103 records image data files for recording, which are stored in the RAM 104, into the recording medium 106. The CPU 103 also reads out image data files recorded in the recording medium 106 and stores those files in the RAM 104. Note that if the image capture apparatus 100 has a communication interface, the CPU 103 may record and read out image data files to and from an external storage device accessible through the communication interface.

A display unit 108 is provided, for example, on the surface of the housing of the image capture apparatus 100, and displays images captured or reproduced, information of the image capture apparatus 100, a graphical user interface, and the like. By capturing a moving image and displaying the moving image simultaneously and continuously, the display unit 108 can be caused to function as an electronic viewfinder (EVF). An operation that causes the display unit 108 to function as an EVF is called a “live view display”, and a moving image displayed in the live view display is called a “live view image”.

“Operation unit 109” is a collective name for input devices (buttons, switches, dials, and the like) provided for a user to input various types of instructions to the image capture apparatus 100. The input devices constituting the operation unit 109 are named according to the functions assigned thereto. For example, the operation unit 109 includes a release switch, a moving image recording switch, a shooting mode selection dial for selecting a shooting mode, a menu button, a directional key, an OK key, and the like. The release switch is a switch for recording still images, and the CPU 103 recognizes a half-pressed state of the release switch as a shooting preparation instruction and a fully-pressed state of the release switch as a shooting start instruction. In addition, the CPU 103 recognizes a moving image recording switch being pressed in a shooting standby state as a moving image recording start instruction, and recognizes the moving image recording switch being pressed during the recording of a moving image as a recording stop instruction. Note that the functions assigned to the same input device may be variable. Additionally, the input devices may include software buttons or keys which use a touchscreen. Additionally, the operation unit 109 may include an input device that corresponds to a non-contact input method, such as voice input, gaze input, or the like.

The image capture apparatus 100 has a function for generating another image by upscaling a part (a partial region) of one image (called a “partial upscaling function” hereinafter). The partial upscaling function can be used for various purposes. For example, the partial upscaling function can be used to implement an electronic zoom function, or provided as an image editing function.

The electronic zoom function uses the partial upscaling function to achieve a zoom ratio exceeding the maximum zoom ratio of the optical system 101. The size of the partial region to be upscaled decreases as the zoom ratio increases. When the electronic zoom function is set to be active and a zoom ratio specified through the operation unit 109 exceeds the maximum zoom ratio of the optical system 101, the CPU 103 determines a partial region to be cropped from the captured image and communicates the partial region to the image processing apparatus 105. The image processing apparatus 105 generates an upscaled image of the partial region communicated from the CPU 103. The image processing apparatus 105 also generates display image data and recording image data based on the upscaled image.

The image editing function provides the user with a function to change the color and brightness of the image, apply rotation and cropping, and the like, for example, when image data already recorded in the recording medium 106 is displayed in the display unit 108. For example, when cropping is applied, the CPU 103 communicates the location and size of the cropped partial region to the image processing apparatus 105. The image processing apparatus 105 generates an upscaled image of the partial region communicated from the CPU 103. The image processing apparatus 105 generates display image data and recording image data based on the upscaled image.

Note that these are only a small number of examples of the uses of the partial upscaling function, and are not intended to limit the uses of the partial upscaling function. The partial upscaling function performed by the image processing apparatus 105 will be described in detail below.

Before describing the partial upscaling function performed by the image processing apparatus 105 in detail, problems that can arise with the related art will be described.

As described above, two processing methods are conceivable when generating an image by upscaling a partial region of an image:
(1) Upscaling the entire input image, and then cropping the region corresponding to the original partial region; or
(2) Cropping the partial region from the input image, and then upscaling the cropped part.

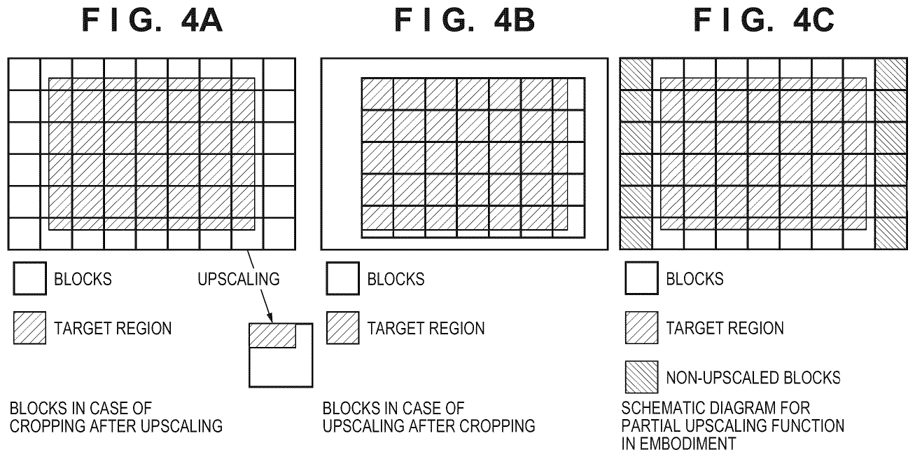

FIGS. 4A and 4B illustrate differences in the division positions of blocks when upscaled images of the same partial region are generated through method (1) and method (2), when the upscaling is performed in units of blocks.

With method (1), the entire original image is divided into blocks, and thus the division positions of the original image do not change regardless of the position of the partial region. On the other hand, with method (2), the partial region is divided into blocks, and thus the division positions of the original image change according to the position of the partial region. In other words, with method (1), the image in each block does not change according to the position of the partial region, but with method (2), the image in each block changes according to the position of the partial region.

The result of the upscaling depends on the original image to which the upscaling is applied. Accordingly, when using method (2), if the position of the partial region is different, the result of upscaling on the same region in the original image will also be different.

The problem with method (2) does not arise with method (1). However, method (1) has a problem that does not arise with method (2), in that upscaling processing is needlessly performed for blocks that do not include the partial region.

In light of these problems, the present embodiment makes it possible to obtain an upscaling result that does not depend on the position of the partial region, while avoiding unnecessary upscaling processing. FIG. 4C schematically illustrates the upscaling processing according to the present embodiment. In the present embodiment, the block division is performed in the same manner as in method (1), but the upscaling processing is not performed for blocks that do not ultimately include the partial region for which an upscaled image is required.

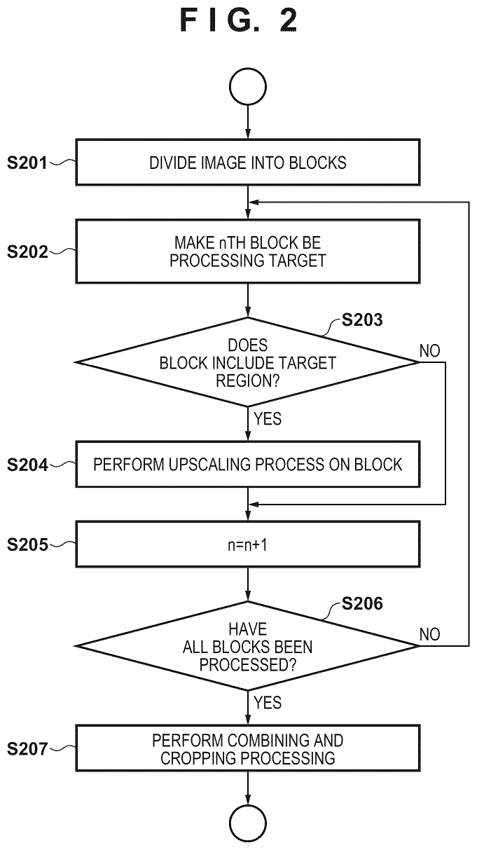

FIG. 2 is a flowchart illustrating the upscaling processing according to the present embodiment. The upscaling processing is assumed to be performed by the image processing apparatus 105 under the control of the CPU 103, for example.

Here, it is assumed that one frame's worth of data of the original image is stored in the RAM 104, and information specifying a partial region in the original image for which an upscaled image is to be generated (also called a “target region” hereinafter) is communicated to the image processing apparatus 105 by the CPU 103.

The original image may be a frame image from a moving image, or may be a still image from a single frame, for example. Alternatively, the original image may be an image from before recording, or may be an image already recorded in the recording medium 106. The partial region may be a region designated by the user, or may be a region determined by the CPU 103. The partial region is a rectangular region, and the information specifying the partial region may be image coordinates of vertices at two opposing corners of the rectangle, for example. Note that the shape of the partial region and the information specifying the partial region are merely examples.

In step S201, the image processing apparatus 105 (dividing means) divides the entire original image into blocks of a predetermined size. Note that as described above, the block size can be determined in accordance with the usable capacity of the RAM 104, the size of the input image that the machine learning model used for ML-based upscaling can handle (e.g., equal to the maximum size of the input image), and the like. The block size may be communicated by the CPU 103, or may be set in advance.

The blocks are rectangular, and thus the image processing apparatus 105 divides the original image in the horizontal direction and the vertical direction. The image processing apparatus 105 associates the image data of each block with information specifying the block (e.g., a raster order number, block coordinates (a number in the horizontal direction and a number in the vertical direction), or the like), and stores that image data in the RAM 104.

The raster order number takes, for example, the block in the upper-left corner as the first block and assigns numbers to the second and subsequent blocks in the horizontal direction. Once a number has been assigned to the rightmost block in that row, numbers are again assigned in order, in the horizontal direction, starting with the leftmost block in the next row of blocks. The block coordinates, meanwhile, can be set such that the block coordinates of the block in the left corner are (1,1) (number in the horizontal direction, number in the vertical direction).

In step S202, the image processing apparatus 105 takes the n-th block in a predetermined processing order (where n is an integer of 1 or more) as the block subject to upscaling processing. The upscaling processing for the n-th block is not performed at this point, however.

In step S203, the image processing apparatus 105 determines whether the block to be processed includes the target region. If so, step S204 is performed, and if not, step S205 is performed. The image processing apparatus 105 can determine whether the block to be processed includes the target region using the position information of the target region, the block size, and the number or position information of the block to be processed.

In step S204, the image processing apparatus 105 (processing means) performs upscaling processing on the block to be processed, and stores the result of the processing in the RAM 104. The image processing apparatus 105 then performs step S205.

In step S205, the image processing apparatus 105 increases the block number to be processed, stored in the RAM 104, for example, by 1. The image processing apparatus 105 then performs step S206.

In step S206, the image processing apparatus 105 determines whether the upscaling processing has been performed for all blocks. If the image processing apparatus 105 determines that the upscaling processing has been performed for all blocks, step S207 is performed, and if not, step S202 is performed.

In step S207, the image processing apparatus 105 (combining means) combines (stitches) the upscaled images of the blocks, stored in the RAM 104, according to the block numbers. As a result, an upscaled image of the part of the original image is obtained, excluding blocks that do not include the target region. The image processing apparatus 105 then crops a region of the obtained upscaled image that corresponds to the target region in the original image, and takes the cropped region as the final upscaled image.

Note that the combining processing can be skipped by storing the upscaling result for each block in the RAM 104 such that, for example, the order of the pixels is maintained. The image processing apparatus 105 stores the data of the upscaled image of the partial region (the target region) of the original image that is ultimately obtained in the RAM 104. The image processing apparatus 105 then generates at least one of the display image data or the recording image data based on the data of the upscaled image.

According to the present embodiment, when an upscaled image of a partial region of an original image is generated using upscaling processing performed in units of blocks, the entire original image is divided into blocks, after which the upscaling processing is performed only on blocks which include the partial region. As a result, problems that occur when dividing the partial region into blocks do not arise, and unnecessary upscaling processing can also be avoided.

### Second Embodiment

A second embodiment of the present invention will be described next. The present embodiment differs from the first embodiment in terms of the upscaling processing performed by the image processing apparatus 105. The following descriptions will therefore focus on the upscaling processing according to the present embodiment.

The present embodiment is similar to method (2) in that the partial region of the original image for which the upscaled image is to be generated is cropped and the upscaling processing is performed in units of blocks, but the block division method is different.

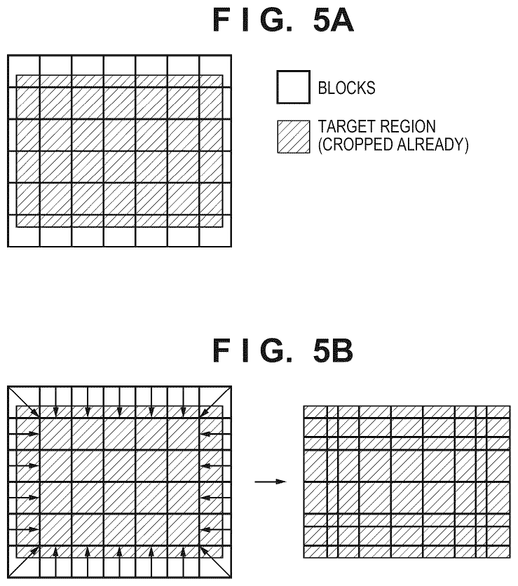

FIG. 5A illustrates a correspondence relationship between the cropped partial region and the blocks in the present embodiment, when an upscaled image is generated for the same partial region as in FIGS. 4A to 4C. In the present embodiment, the partial region after cropping is divided into blocks at the same positions used when dividing the entire image into blocks.

This makes it possible to avoid the problem of method (2), which is caused by the division positions being different depending on the position of the partial region. On the other hand, dividing the blocks at positions regardless of the position of the partial region may result in the outermost blocks not being filled with pixels (i.e., having regions where there are no pixels). The upscaling processing may be performed as-is for blocks that have a small (not greater than a predetermined threshold) percentage of pixels that are not present (or a percentage of regions where there are no pixels) relative to the block size (the total number of pixels).

On the other hand, for blocks that have a small (not greater than a predetermined threshold) percentage of pixels that are not present relative to the block size (the total number of pixels), the upscaling processing is performed having supplemented the pixels that are not present. Any desired method can be used to supplement the pixels, such as supplementing achromatic pixels, for example. FIG. 5B illustrates an example of supplementing the pixels that are not present by moving the positions of the outermost blocks to positions that are within the partial region.

In the example in FIG. 5B, the positions of the blocks having regions where there are no pixels are shifted in a direction that shrinks the regions in which the pixels are not present until the blocks are filled with pixels. This can also be said to be shifting the position of the block into the partial region. For example, a block in which the region where there are no pixels is present at the top of the block is shifted downward, and a block in which the region where there are no pixels is present at the bottom of the block is shifted upward. Likewise, a block in which the region where there are no pixels is present on the left side of the block is shifted rightward, and a block in which the region where there are no pixels is present on the right side of the block is shifted leftward. A block in which a region where there are no pixels is present in multiple directions, such as the blocks in the four corners, is shifted diagonally. For example, with the block in the upper-left corner, a region where there are no pixels is present at the top and on the left, and that block is therefore shifted in the lower-right direction (or downward until the region at the top is filled with pixels, and then rightward until the region on the left is filled with pixels).

The left side of FIG. 5B illustrates the directions in which the outermost blocks are shifted, and the right side illustrates the positions of the blocks after the shift. Although the same problem occurs as in method (2) for the shifted blocks, the results of the upscaling on the shifted blocks are used only in the parts where the partial region was present at the positions before the shift, and there is therefore little impact on the overall upscaled image.

Although FIG. 5B illustrates a case where all the outermost blocks are shifted, a configuration in which only blocks where the percentage of pixels that are not present exceeds a threshold are shifted may be used. It goes without saying that if the entire periphery of the partial region coincides with the division positions of the blocks, there will be no blocks having a region where there are no pixels, and supplementing pixels will therefore be unnecessary.

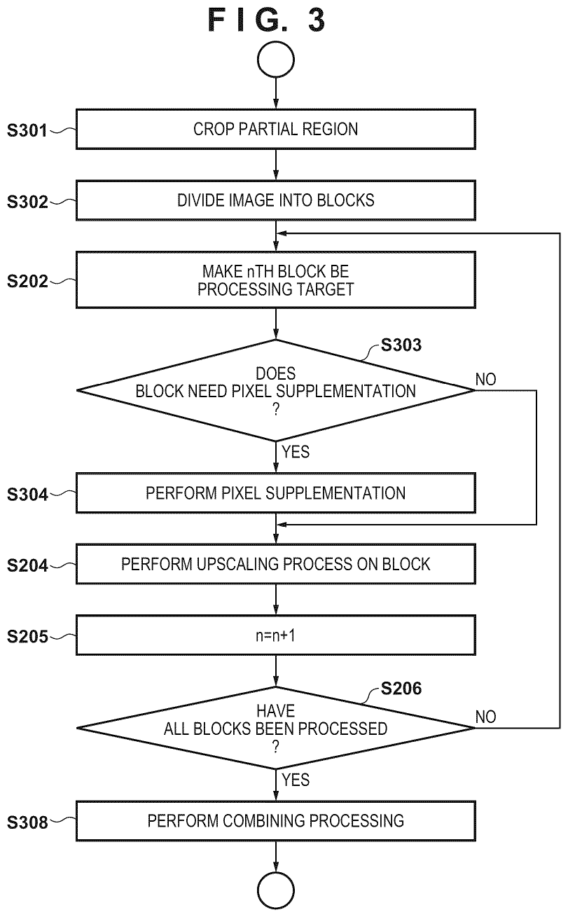

FIG. 3 is a flowchart illustrating the upscaling processing according to the present embodiment. The upscaling processing is assumed to be performed by the image processing apparatus 105 under the control of the CPU 103, for example. In FIG. 3, steps that perform processes identical to those in the first embodiment have been given the same reference numerals as in FIG. 2, and will not be described. The present embodiment, too, assumes that information specifying a partial region for which an upscaled image is to be generated is communicated to the image processing apparatus 105 by the CPU 103.

In step S301, the image processing apparatus 105 (cropping means) crops the partial region from the original image. The image processing apparatus 105 stores the data of the cropped partial region in the RAM 104.

In step S302, the image processing apparatus 105 divides the cropped partial region into blocks. Here, the image processing apparatus 105 divides the partial region into blocks at the same positions used when dividing the entire original image into blocks. Specifically, when the partial region is expressed using the coordinate system of the original image, the image processing apparatus 105 divides the partial region in the horizontal direction at positions corresponding to a multiple of the horizontal direction size of the blocks, and divides the partial region in the vertical direction at positions corresponding to a multiple of the vertical direction size of the blocks. The image processing apparatus 105 treats the outermost blocks as blocks of a normal size even if the blocks are smaller than the block size in at least one of the horizontal direction or the vertical direction.

In step S303, the image processing apparatus 105 determines whether the block to be processed requires pixels to be supplemented. For example, the image processing apparatus 105 can determine that the block to be processed requires pixels to be supplemented if the percentage of regions where there are no pixels relative to the entire block to be processed exceeds a threshold. If the image processing apparatus 105 determines that the block to be processed requires pixels to be supplemented, step S304 is performed, and if not, step S204 is performed.

In step S304, the image processing apparatus 105 supplements pixels for the block to be processed. As described above, the pixel supplementing can be performed through various methods. The image processing apparatus 105 stores information specifying the region where pixels have been supplemented or the region where pixels have not been supplemented (the region where pixels were originally present) in association with the block. For example, the image processing apparatus 105 can record position information of the vertices at two opposing corners of the rectangular region where pixels were present in association with the block. When shifting a block for pixel supplementation, the image processing apparatus 105 also stores the amount of shift in the horizontal direction and the vertical direction in association with the block.

If in step S206 the image processing apparatus 105 determines that the upscaling processing has been performed for all blocks, step S308 is performed, and if not, step S202 is performed.

In step S308, the image processing apparatus 105 combines (stitches) the upscaled images of the blocks, stored in the RAM 104, according to the block numbers. As a result, an upscaled image of the part of the original image is obtained, excluding blocks that do not include the target region.

Note that for blocks where pixels have been supplemented, the image processing apparatus 105 uses, in the combining, only the image region corresponding to the part, of the upscaled image of the block, that was included in the block before the pixels were supplemented. If the block has shifted, the image processing apparatus 105 uses, in the combining, only the image region corresponding to the part, of the upscaled image of the block, that was included in the block at the position from before the shift.

According to the present embodiment, the same effects as those of the first embodiment can be achieved for blocks filled with pixels, even if the upscaling processing is performed for each block after first cropping the partial region for which the upscaled image is to be generated. Furthermore, there are very few, if any, blocks that include regions where there are no pixels, and those blocks will therefore have very little effect on the upscaled image.

### Third Embodiment

A third embodiment of the present invention will be described next. The present embodiment is an embodiment that can be carried out selectively with the first embodiment or the second embodiment. The present embodiment can be carried out by the image capture apparatus 100, and will therefore be described as being carried out by the image capture apparatus 100 hereinafter.

In the first and second embodiments, the impact of the position of the target region on the upscaling result was suppressed by dividing the original image at fixed positions. However, it is necessary to perform the upscaling processing on blocks that include even a small part of the target region, and thus more efficient upscaling processing may be performed when, for example, it is necessary to perform the processing in a short period of time.

The present embodiment is upscaling processing that can be performed in place of the upscaling processing according to the first embodiment and the second embodiment. The upscaling processing according to the present embodiment can be performed, for example, when the user explicitly selects the upscaling processing according to the present embodiment from a menu screen, when a predetermined shooting mode is set, or the like. The upscaling processing according to the present embodiment can be performed not only when the settings of the image capture apparatus 100 satisfy a predetermined condition, but also, for example, when the CPU 103 determines that a dynamic factor such as the processing load of the image processing apparatus 105 satisfies a predetermined condition.

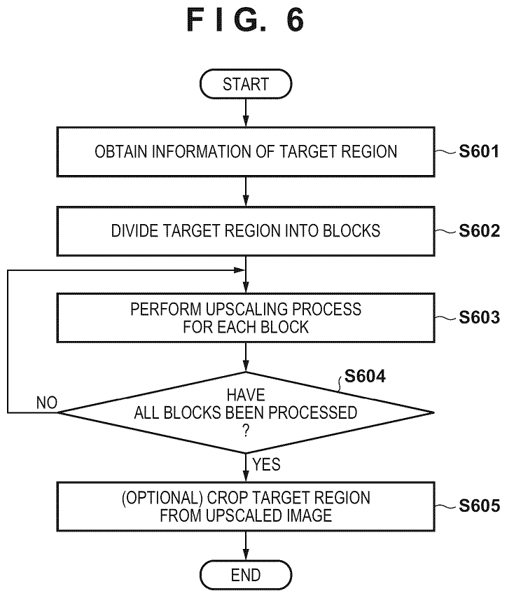

FIG. 6 is a flowchart illustrating the upscaling processing according to the present embodiment. The upscaling processing is assumed to be performed by the image processing apparatus 105 under the control of the CPU 103, for example.

In step S601, the image processing apparatus 105 obtains information specifying the target region of the original image. In the present embodiment too, the target region may be a region designated by the user, or may be a region determined by the CPU 103, for example. Furthermore, the partial region is a rectangular region, and the information specifying the partial region may be image coordinates of vertices at two opposing corners of the rectangle, for example.

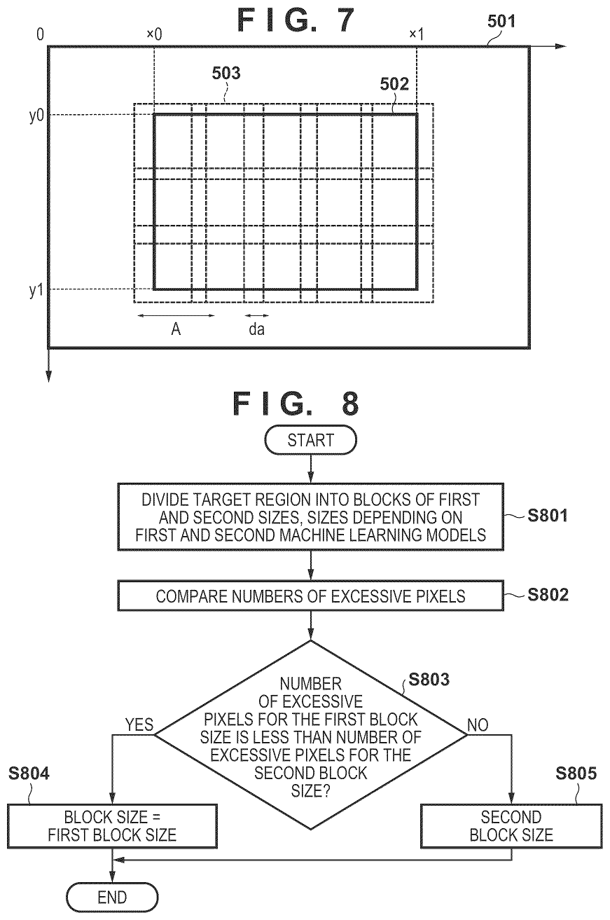

In step S602, the image processing apparatus 105 specifies the target region from the information obtained in step S601, and divides the target region into a plurality of blocks. As described above, the image processing apparatus 105 according to the present embodiment can divide the target region into a plurality of blocks at positions based on the position of the target region. FIG. 7 is a schematic diagram illustrating an example of the target region and the block division. 501 indicates the original image, and 502 indicates the target region. Each block is a square having A pixels to a side, and each block is indicated by dotted lines. FIG. 7 illustrates a case where the target region is divided into a plurality of blocks such that the adjacent blocks have overlapping regions which overlap by several pixels (a pixel number da). However, the overlapping region da is not necessarily required. 503 indicates a region used for the upscaling processing on the target region (a processing region).

Here, an image coordinate system is assumed in which the vertex at the upper-left of the original image 501 is the origin (0,0), an x-axis extends horizontally rightward from the origin, and a y-axis extends vertically downward from the origin. Furthermore, the image coordinates at the vertex at the upper-left of the target region are represented by (x0,y0), and the coordinates at the vertex at the lower-right are represented by (x1,y1).

The region 503 used for the upscaling processing is determined so as to contain the target region 502, and thus assuming a size of A for each side of the block and a pixel number of da of the overlapping region between adjacent blocks, a number of blocks Nx in the horizontal direction and a number of blocks Ny in the vertical direction are the smallest integers satisfying the respective following formulae.

$$Nx > ( x 1 - x 0 - 2 da ) / ( A - da ) \qquad ( 1 )$$

$$Ny > ( y 1 - y 0 - 2 da ) / ( A - d a ) \qquad ( 2 )$$

Note that if no overlapping region between blocks is provided, da=0 in formulae (1) and (2).

In step S603, the image processing apparatus 105 performs the upscaling processing for each block obtained from the division performed in step S602, and stores the results in the RAM 104, for example. The upscaling processing may or may not be ML-based upscaling processing.

In step S604, the image processing apparatus 105 determines whether the upscaling processing has been performed for all blocks. If the image processing apparatus 105 determines that the upscaling processing has been performed for all blocks, step S605 is performed, and if not, step S603 is repeated.

In step S605, the image processing apparatus 105 combines (stitches) the upscaled images of the blocks, stored in the RAM 104, according to the block positions. If at this time there are overlapping regions between blocks, the overlapping regions are deleted before the combining is performed. The combined image will include a region outside the target region if at least one of the horizontal direction size (x1-x0) or the vertical direction size (y1-y0) of the target region is not a multiple of A. In this case, the image processing apparatus 105 removes the region outside the target region (crops the part corresponding to the target region from the combined image) and takes the result as the final upscaled image.

With the upscaling processing according to the present embodiment, the block division positions differ depending on the target region, and thus the effect provided by the upscaling processing according to the first embodiment and the second embodiment is not achieved. However, the upscaling processing according to the present embodiment is easier than the upscaling processing according to the first or second embodiment, and can therefore be performed selectively, which enables flexible upscaling processing according to the user's intentions, the state of the image capture apparatus 100, and the like.

### Fourth Embodiment

A fourth embodiment of the present invention will be described next. The present embodiment relates to a method for determining the block size in the upscaling processing performed in units of blocks in the first to third embodiments. The present embodiment can be carried out by the image capture apparatus 100, and will therefore be described as being carried out by the image capture apparatus 100 hereinafter.

As described earlier, performing upscaling processing for unnecessary regions leads to a waste of time, power, and the like required for the upscaling processing. It is therefore important to use an appropriate block size. A method for determining the block size when first and second machine learning models having different input image sizes are prepared in advance to perform ML-based upscaling processing will be described here.

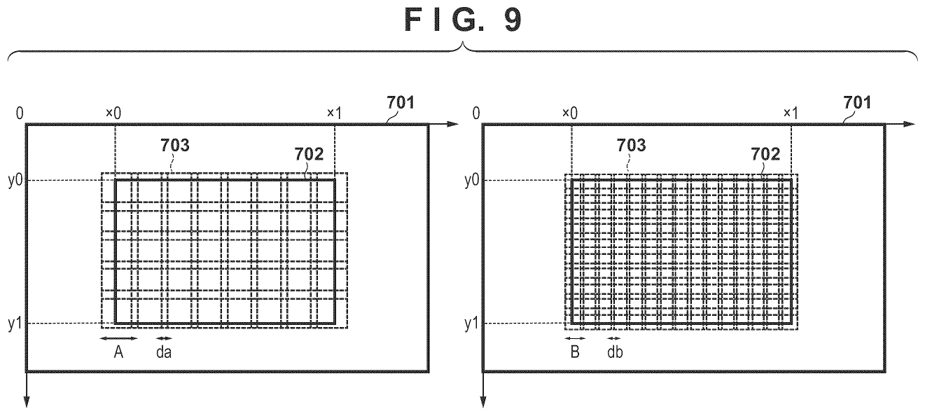

FIG. 8 is a flowchart illustrating block size determination processing according to the present embodiment. The determination processing can be performed by the image processing apparatus 105 at the beginning of step S204 or step S603 (before the upscaling processing is started).

In step S801, the image processing apparatus 105 divides the original image (if performed in step S204) or the target region (if performed in step S603) into blocks of a first block size and a second block size, respectively. The first block size is an input image size for the first machine learning model, and the second block size is an input image size for the second machine learning model.

In step S802, the image processing apparatus 105 calculates the number of pixels outside the target region where the upscaling processing is performed (the number of excessive pixels) for when dividing at the first block size and for when dividing at the second block size. The image processing apparatus 105 then compares the calculated numbers of excessive pixels.

FIG. 9 is a diagram illustrating processing performed in step S802 for calculating the numbers of excessive pixels. FIG. 9 illustrates a case where the same block division method as in the third embodiment is performed. 701 indicates the original image, 702 indicates the target region, 703 indicates the region used for upscaling processing when dividing at the first block size, and 704 indicates the region used for upscaling processing when dividing at the second block size. The image coordinate system and the coordinates of the target region are the same as in the third embodiment.

A number of pixels M in the target region is obtained through the following formula (3).

$$M = ( x 1 - x 0 ) * ( y 1 - y 0 ) \qquad ( 3 )$$

A number of pixels M1 of the region 703 used for upscaling processing when dividing at the first block size is obtained through the following formula (4), using the number of blocks Nx in the horizontal direction, the number of blocks Ny in the vertical direction, the block size A, and the number of overlapping pixels da between adjacent blocks.

$$M 1 = [ Nx 1 * A - ( Nx 1 - 1 ) * d a ] * [ Ny 1 * A - ( Ny 1 - 1 ) * d a ] \qquad ( 4 )$$

The number of excessive pixels is obtained as M1-M.

A number of pixels M2 of the region 704 used for upscaling processing when dividing at the second block size is obtained through the following formula (5), using a number of blocks Nx2 in the horizontal direction, a number of blocks Ny2 in the vertical direction, a block size B, and a number of overlapping pixels db between adjacent blocks.

$$M 2 = [ Nx 2 * B - ( Nx 2 - 1 ) * db ] * [ N y 2 * B - ( N y 2 - 1 ) * d b ] \qquad ( 5 )$$

The number of excessive pixels is obtained as M2-M.

In step S803, the image processing apparatus 105 determines whether the number of excessive pixels when dividing at the first block size is less than the number of excessive pixels when dividing at the second block size. If the image processing apparatus 105 determines that the number of excessive pixels when dividing at the first block size is less than the number of excessive pixels when dividing at the second block size, step S804 is performed, and if not, step S805 is performed.

In step S804, the image processing apparatus 105 determines that each block obtained by dividing at the first block size is to be upscaled using the first machine learning model.

In step S805, the image processing apparatus 105 determines that each block obtained by dividing at the second block size is to be upscaled using the second machine learning model.

According to the present embodiment, when, for example, a plurality of machine learning models having different input image sizes are prepared for upscaling processing, a more appropriate block size can be used, which makes it possible to implement more efficient upscaling processing. Although the foregoing described a case where there are two types of block sizes, the technique can be applied in the same manner even when there are three or more types of block sizes.

Note that the upscaling processing according to the third and fourth embodiments can be used to implement cropping or an electronic zoom function, provided as an image editing function, or the like, in the same manner as in the first and second embodiments. There are cases where the post-cropping number of pixels is fixed for cropping, electronic zoom, and the like. In such a case, the excessive pixels described in the fourth embodiment are known in advance, which makes it possible to switch the learning model referenced in the upscaling in accordance with the number of cropped pixels. Although embodiments in an image capture apparatus have been described, the technique can also be applied in an electronic device that does not have an image capture function, such as an information processing apparatus.

### OTHER EMBODIMENTS

The foregoing embodiments described a case where the partial region is divided at the same positions used when dividing the entire original image. However, if the partial region is divided at fixed positions in the coordinate system of the original image, the problem with method (2) can still be solved even if the partial region is not necessarily divided at the same positions used when dividing the entire original image.

Embodiment(s) of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Applications No. 2023-123765, filed Jul. 28, 2023 and No. 2024-024825, filed Feb. 21, 2024, which are hereby incorporated by reference herein in their entirety.

What is claimed is:

1. An image processing apparatus comprising:
one or more processors that execute a program stored in a memory and thereby function as:
a dividing unit configured to divide an image into a plurality of blocks;
a processing unit configured to perform upscaling processing on each of the plurality of blocks; and
a combining unit configured to combine upscaled images of the plurality of blocks into one upscaled image,
wherein, in a case where an upscaled image of a partial region of an original image is to be generated,
the dividing unit divides the partial region into a plurality of blocks at predetermined positions regardless of a position of the partial region in the original image.

2. The image processing apparatus according to claim 1,
wherein, in a case where the upscaled image of the partial region is to be generated,
the dividing unit divides all of the original image into the plurality of blocks at the predetermined positions, and
the processing unit does not perform the upscaling processing on a block, among the plurality of blocks, that does not include the partial region.

3. The image processing apparatus according to claim 2, wherein the one or more processors further function as a cropping unit configured to crop a part corresponding to the partial region from the one upscaled image obtained by the combining unit.

4. The image processing apparatus according to claim 1,
wherein in a case where an upscaled image of a partial region of an original image is to be generated,
the dividing unit divides the partial region cropped from the original image into the plurality of blocks at the predetermined positions.

5. The image processing apparatus according to claim 4,
wherein for a block, among the plurality of blocks, that includes a region in which pixels are not present, the processing unit performs the upscaling processing after supplementing pixels that are not present.

6. The image processing apparatus according to claim 5,
wherein the processing unit supplements the pixels that are not present by shifting a position of the block that includes a region in which the pixels are not present within the partial region.

7. The image processing apparatus according to claim 5,
wherein for an upscaled image of the block that includes the supplemented pixels, the combining unit uses, in the combining, only a region corresponding to a part that was included in the block before the pixels were supplemented.

8. The image processing apparatus according to claim 5,
wherein for a block, among the plurality of blocks, in which a percentage of the region in which pixels are not present is not greater than a threshold, the processing unit does not supplement the pixels that are not present.

9. The image processing apparatus according to claim 1,
wherein the predetermined position is based on a multiple of a size of the block.

10. The image processing apparatus according to claim 1,
wherein the processing unit performs the upscaling processing using a trained machine learning model of which an input image is one of the plurality of blocks, and
the dividing unit divides the image into the plurality of blocks such that each of the plurality of blocks in a size determined in accordance with a size of an input image that the trained machine learning model can handle.

11. The image processing apparatus according to claim 1,
wherein the dividing unit can selectively divide the partial region into the plurality of blocks at positions based on the position of the partial region.

12. The image processing apparatus according to claim 11,
wherein the dividing unit divides the partial region into a plurality of blocks at positions based on the position of the partial region in case where a setting of the image processing apparatus or a dynamic factor satisfies a predetermined condition.

13. The image processing apparatus according to claim 1,
wherein the dividing unit divides the image into the plurality of blocks such that each of the plurality of blocks in a size selected from a plurality of sizes.

14. The image processing apparatus according to claim 13,
wherein the plurality of sizes are sizes of input images of a plurality of machine learning models that perform the upscaling processing.

15. The image processing apparatus according to claim 13,
wherein in a case where a number of pixels that are not in the partial region in a block, among the plurality of blocks, that includes the partial region when dividing the image into a plurality of blocks in a first block size is smaller than that when dividing the image into a plurality of blocks in a second block size, the dividing unit selects the first block size.

16. An image processing apparatus comprising:
one or more processors that execute a program stored in a memory and thereby function as:
a dividing unit configured to divide an image into a plurality of blocks;
a processing unit configured to perform upscaling processing on each of the plurality of blocks; and
a combining unit configured to combine upscaled images of the plurality of blocks into one upscaled image,
wherein in a case where an upscaled image of a partial region of an original image is to be generated,
the processing unit sets a processing region that contains the partial region and that is smaller than the original image and larger than the partial region, and performs the upscaling processing for each of a plurality of blocks obtained by dividing the processing region in accordance with a position of the partial region, and
the partial region of the one upscaled image obtained by the combining unit is cropped.

17. An image capture apparatus comprising:
an image sensor; and
an image processing apparatus that takes an image captured using the image sensor as an original image,
wherein the image processing apparatus comprising:
one or more processors that execute a program stored in a memory and thereby function as:
a dividing unit configured to divide an image into a plurality of blocks;
a processing unit configured to perform upscaling processing on each of the plurality of blocks; and
a combining unit configured to combine upscaled images of the plurality of blocks into one upscaled image,
wherein, in a case where an upscaled image of a partial region of an original image is to be generated,
the dividing unit divides the partial region into a plurality of blocks at predetermined positions regardless of a position of the partial region in the original image.

18. The image capture apparatus according to claim 17,
wherein the upscaling processing is used to implement an electronic zoom function.

19. An image processing method performed by an image processing apparatus, the image processing method comprising:
dividing an image into a plurality of blocks;
performing upscaling processing on each of the plurality of blocks; and
combining upscaled images of the plurality of blocks into one upscaled image,
wherein in a case where an upscaled image of a partial region of an original image is to be generated,
the dividing divides the partial region into a plurality of blocks at predetermined positions regardless of a position of the partial region in the original image.

20. An image processing method performed by an image processing apparatus, the image processing method comprising:
dividing an image into a plurality of blocks;
performing upscaling processing on each of the plurality of blocks; and
combining upscaled images of the plurality of blocks into one upscaled image,
wherein in a case where an upscaled image of a partial region of an original image is to be generated,
the performing of the upscaling processing sets a processing region that contains the partial region and that is smaller than the original image and larger than the partial region, and performs the upscaling processing for each of the plurality of blocks obtained by dividing the processing region in accordance with a position of the partial region, and
the partial region of the one upscaled image obtained from the combining is cropped.
